(19) United States
(12) Patent Application Publication
(10) Pub. No.: US 2023/0406148 A1
(43) Pub. Date: Dec. 21, 2023

(54) Artificial Intelligence Platform for Vehicle Electrification

(71) Applicant: 14156048 Canada Inc., Vaughan (CA)

(72) Inventors: David Arsenault, Montreal (CA); François Rainville, Chambly (CA)

(73) Assignee: 14156048 Canada Inc., Vaughan, ON (CA)

(21) Appl. No.: 18/251,134

(22) PCT Filed: Oct. 14, 2021
(86) PCT No.: PCT/CA2021/051441

§ 371 Date: Apr. 28, 2023

Related U.S. Application Data
(60) Provisional application No. 63/107,095, filed on Oct. 29, 2020.

(51) Int. Cl. B60L 53/68; B60L 53/12; B60L 53/67; B60L 53/64; B60L 53/63

(52) U.S. Cl. CPC B60L 53/68; B60L 53/12; B60L 53/67; B60L 53/64; B60L 53/63

(57) ABSTRACT

An artificial intelligence platform for electrification of a fleet of vehicles and an energy distribution system are described. The energy distribution system comprises a number of electric energy storage devices associated with vehicles in the fleet, as well as charging points. The configuration of the electric energy storage devices and the charging points is determined using an artificial intelligence platform and vehicle positional and energy consumption information. The platform allows for the iterative implementation of the process of electrification in a simple and predictable manner, given specific constraints, and provides energy distribution systems for electrical vocational vehicles in a flexible and cost-effective manner.

### CROSS REFERENCE TO RELATED APPLICATION

This application claims the benefit of U.S. Provisional Patent Application No. 63/107,095, filed Oct. 29, 2020, which is incorporated herein by reference in its entirety.

### FIELD

The present disclosure relates to the general field of vehicle electrification. In particular, the present disclosure relates to electric vehicles, electric vehicle energy distribution systems and artificial intelligence systems and methods for providing electric vehicle energy distribution systems.

### INTRODUCTION

In recent years, efforts have been made to transition vehicles, including vocational vehicles, away from fossil fuels and towards electrical power systems; a process known as electrification.

While such electrical power systems provide a number of technical advantages over fuel-based systems (e.g. a reduction in greenhouse gas emissions and readily accessible power), electrical vehicle energy distribution systems, if improperly designed, can lead to some significant technical disadvantages. Such disadvantages include vehicle downtime caused by vehicles running out of electric charge prior to reaching charging points, and vehicle downtime spent travelling to charging points and charging. Furthermore, in most known systems, these disadvantages represent an inescapable tradeoff between the amount of energy contained in a vehicle's onboard rechargeable power source (e.g. rechargeable battery) and the time required to charge that power source. That is to say that increasing the energy storage capacity (e.g. increasing the battery size) of vehicles in order to mitigate against the problem of running out of charge, invariably results in an increase in charging time, thereby increasing vehicle downtime and the incremental cost of adding electric vehicles, as compared to, for example, equivalent diesel-powered vehicles.

Accordingly, for some applications (e.g. in certain industry settings), the process of electrification requires not only replacement (or alteration) of vehicles, but also the design and provisioning of energy distribution systems that will attempt to minimize at least some of the above disadvantages.

Some systems have been developed that provide energy distribution systems which require periodic routing of electric vehicles to charging stations while vehicles are not in vocational use (i.e. while a vehicle is not performing the tasks—such as lifting, hauling, loading/unloading—for which it is intended). Such charging, if appropriately scheduled, can avoid most instances of vehicles running out of charge. Because such charging is performed while vehicles are not in vocational use however, such scheduling does little to decrease vehicle downtime spent travelling to charging points and charging.

Other systems have been developed that provide energy distribution systems including charging stations positioned along routes used by vehicles during vocational use (e.g. at bus stops along predetermined routes). While such known systems can alleviate some of the disadvantages related to previous solutions, they produce energy distribution systems that are inflexible (e.g. requiring vehicles to use predetermined routes). This inflexibility in turn increases the difficulties in progressively transitioning from fleets of fully fuel-based vehicles to fleets of fully electric vehicles (i.e. such inflexible systems are therefore not easily scalable).

Yet other systems have been developed that provide energy distribution systems including mobile charging stations designed to travel to and from vehicles requiring charging. As will be appreciated by the skilled reader, mobile charging stations themselves eventually require charging and are therefore inherently limited in their capacity to recharge vocational vehicles. Accordingly, for most applications, solutions based on mobile charging stations are prohibitively complex and costly.

Moreover, if opting for the systems described above, the capital investment required to both replace a fleet of fuel-based vehicles with electric vehicles, and to provide a sufficiently-large network of charging stations, can be prohibitive. This has led many in industry and government to either put off or altogether forgo electrification, which has exacerbated an already serious global environmental crisis.

There is thus a clear need for intelligent systems and methods for providing energy distribution systems for electric vocational vehicles in a flexible and cost-effective manner.

### SUMMARY

The following summary is intended to introduce the reader to the more detailed description that follows, and not to define or limit the claimed subject matter.

The claimed subject matter provides the advantages of allowing users of the systems and methods described herein to iteratively implement the process of electrification in a simple and predictable manner, given specific constraints. The claimed subject matter also provides the advantages of providing energy distribution systems for electrical vocational vehicles in a flexible and cost-effective manner.

According to one aspect of the present disclosure, there is provided a system for electrification of a fleet of vehicles using an energy distribution system. The energy distribution system comprises a number of electric energy storage devices defining an electric energy storage capacity associated with each vehicle in a group of vehicles in the fleet. The energy distribution system also comprises a group of installed charging points, each installed charging point being associated with a location in an area. The system for electrification of a fleet of vehicles comprises a processor and at least one non-transitory memory containing instructions which when executed by the processor cause the system to receive positional information relating to the position of one or more vehicles in the fleet over time and receive energy consumption information relating to the energy consumed by the one or more vehicles in the fleet over time. The instructions further cause the system to determine, based on the received positional information, the energy consumption information, the electric energy storage capacity associated with each vehicle in the group of vehicles and the locations associated with the installed charging points of the group of installed charging points, a number of additional charging points, an optimal location within the area associated with each of the additional charging points and an optimal electric energy storage capacity associated with each of the one or more vehicles. The number of additional charging points, the optimal locations associated with each of the additional charging points and the optimal electric energy storage capacities associated with the one or more vehicles are determined such that the number of additional charging points is minimized and the utilizations of the optimal electric energy storage capacities are maximized.

According to another aspect of the present discloses, there is provided a computer-implemented method for electrification of a fleet of vehicles using an energy distribution system. The energy distribution system comprises a number of electric energy storage devices defining an electric energy storage capacity associated with each vehicle in a group of vehicles in the fleet. The energy distribution system also comprises a group of installed charging points, each installed charging point being associated with a location in an area. The computer-implemented method comprises the steps of receiving positional information relating to the position of one or more vehicles in the fleet over time and receiving energy consumption information relating to the energy consumed by the one or more vehicles in the fleet over time. The computer-implemented method also comprises the step of determining, based on the received positional information, the energy consumption information, the electric energy storage capacity associated with each vehicle in the group of vehicles and the locations associated with the installed charging points of the group of installed charging points, a number of additional charging points, an optimal location within the area associated with each of the additional charging points and an optimal electric energy storage capacity associated with each of the one or more vehicles. The number of additional charging points, the optimal locations associated with each of the additional charging points and the optimal electric energy storage capacities associated with the one or more vehicles are determined such that the number of additional charging points is minimized and the utilizations of the optimal electric energy storage capacities are maximized.

According to yet another aspect of the present disclosure, there is provided an energy distribution system for a fleet of vehicles. The energy distribution system comprises one or more electric energy storage devices associated with each vehicle in a group of vehicles. The energy distribution system also comprise one or more electric charging points configured to wirelessly charge the one or more electric energy storage devices, each electric charging point being positioned at a specific location in an area. The specific locations of the one or more charging points and the number of electric energy storage devices are determined using previous location information and previous energy consumption information associated with the group of vehicles.

According to yet another aspect of the present disclosure, there is provided a vehicle that comprises one or more electric energy storage devices. The vehicle also comprises a wireless power transmission receiver configured to charge the one or more electric energy storage devices and a secondary electric energy source configured to charge the one or more electric energy storage devices.

### DRAWINGS

In order that the claimed subject matter may be more fully understood, reference will be made to the accompanying drawings, in which:

FIG. 1 is a schematic diagram showing a wireless energy distribution system in accordance with examples disclosed herein;

FIG. 2 is a schematic diagram of functional components used by a vehicle and a charging point in accordance with examples disclosed herein;

FIG. 3 is a schematic diagram of a system in accordance with examples disclosed herein;

FIG. 4 is a schematic block diagram of an example method carried out by the system of FIG. 3;

FIG. 5 is an illustration from an aerial perspective of a site which can be provided with energy distribution systems using the systems and methods disclosed herein;

FIG. 6 is an illustration of a heat map relating to vehicle activity on the site shown in FIG. 5;

FIG. 7 is an illustration from an aerial perspective of an example energy distribution system provided by the systems and methods disclosed herein;

FIG. 8 is an illustration of an example User Interface that can be provided to users of the systems and methods described herein;

FIG. 9 is an illustration from an aerial perspective of another example energy distribution system provided by the systems and methods disclosed herein; and

FIG. 10 is an illustration from an aerial perspective of yet another example energy distribution system provided by the systems and methods disclosed herein.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. Numerous specific details are set forth in order to provide a thorough understanding of the exemplary embodiments of the subject matter described herein.

However, it will be understood by those of ordinary skill in the art that the embodiments described herein may be practiced without these specific details. In other instances, well-known methods, procedures and components have not been described in detail so as not to obscure the present subject matter. Furthermore, this description is not to be considered as limiting the scope of the subject matter in any way but rather as illustrating the various embodiments.

As used herein, a “low storage capacity, rapid recharge, high cycle life electric energy storage device” means an electric energy storage device having a cycle life of at least 20,000 to one million cycles, and being able to recharge from about 40% to about 100% of maximum energy storage capacity in fewer than five minutes. Examples of low storage capacity, rapid recharge, high cycle life electric energy storage devices include, but are not limited to, ultracapacitors (also known as supercapacitors) and lithium-titanate (LTO) batteries.

As used herein, a “vocational vehicle” means any vehicle which is intended for particular purposes such as, but not limited to, carrying passengers, lifting, hauling, loading/unloading materials and cargo, delivering packages, digging, collecting, towing and dumping. Such vocational vehicles include, but are not limited to, dump trucks, urban buses, Mobile Elevated Work Platforms (MEWP), refuse trucks, delivery vehicles, terminal tractors, mobile billboard trucks, reach stackers, concrete mixers, school buses and mobile cranes.

As used herein, “integral equipment” of a vocational vehicle means components and/or systems that are conventionally included on the vehicle and powered by the engine, or the battery, such as lights, electric fans, a radio, the air conditioning compressor, the power steering fluid pump, an air brake system, an engine coolant pump, and/or a fuel pump, transmission oil pump.

As used herein, “peripheral equipment” for a vocational vehicle means components and/or systems that are not conventionally included on the vehicle, and that provide complementary functions that may be unrelated to the primary function of the vehicle, such as, for example, elevated work platforms, cranes, hoists, hydraulic systems and output electric power.

As defined herein, the “electric energy storage capacity” of a vehicle is the sum of the electric energy storage capacities (in kWh) of the electric energy storage devices used by the vehicle, as described in more detail herein.

As defined herein, “utilization” of an electric energy storage device means the capacity utilization (in percentage) of the electric energy storage device, which is the average amount of energy stored and dispensed in each recharge cycle of the electric energy storage device as a proportion of the maximum energy storage capacity of the electric energy storage device. Similarly, as defined herein, “utilization” of an electric energy storage capacity means the capacity utilization (in percentage) of the electric energy storage capacity associated with a vehicle, which is the average amount of energy stored and dispensed in each recharge cycle of the electric energy storage capacity associated with the vehicle as a proportion of the maximum electric energy storage capacity associated with the vehicle.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

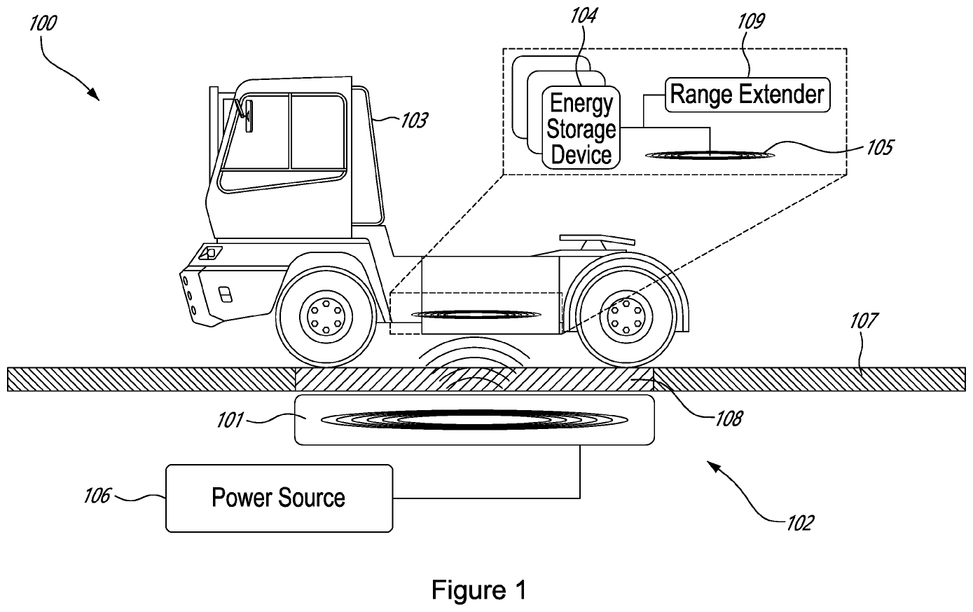

FIG. 1 shows a wireless energy distribution system 100 in accordance with examples of the present disclosure. The wireless energy distribution system 100 comprises two main components, namely a wirelessly chargeable unit located on a vocational vehicle 103 and a wireless charging point 102.

The wireless charging point 106 comprises a Resonant Magnetic Induction (RMI) transmitter pad 101 and a power source 106. In some embodiments, the power source 106 can comprise a connection to utility power (also known as mains electricity, the power grid or hydro). In other embodiments, the power source 106 can itself be a chargeable energy storage device, such as a battery. In some embodiments, the power source 106 can be supplied by a renewable energy source, such as electricity generated by solar or wind power.

In some embodiments, the power source 106 provides electrical power to RMI transmitter pad 101. In other embodiments, other wireless charging technologies, such as, but not limited to, magnetic-resonance wireless charging may be used. For the sake of simplicity and clarity, the examples disclosed herein are described with reference to Resonant Magnetic Induction (RMI) charging. RMI charging technologies mitigate against drops in efficiency caused by distances between a transmitting coil and a receiving coil by operating both coils at the same resonant frequency, thereby increasing the strength of inductive coupling and mitigating leakage over greater distances between coils.

As shown in FIG. 1, in some embodiments, the wireless charging points 106 are located underground. In such cases, the RMI transmitter pad 101 can be located beneath the pavement upon which the vocational vehicle 103 travels. Alternatively, as shown in FIG. 1, the pavement 107 may be removed over the area covering the RMI transmitter pad 101 and a replacement material 108 may be provided to aid in inductive coupling. In other embodiments, the composition of the asphalt forming the pavement 107 may be modified over the area covering the RMI transmitter pad 101 for the same or similar purposes.

Vocational vehicle 103 includes a wirelessly chargeable unit that is made up of a RMI receiver pad 105 and a scalable bank of electric energy storage devices 104. Each electric energy storage device 104 can be recharged using the electricity produced by the RMI receiver pad 105. The wirelessly chargeable unit also comprises a range extender 109.

The range extender 109 can be any device that provides the electric energy storage devices 104 with an alternate source of energy. For example, the range extended could include a lithium-ion battery or other types of electrical storage device and/or internal combustion engines, as describe in more detail herein. For the sake of simplicity and clarity, the examples disclosed herein are described with reference to a range extender comprising a diesel-powered engine coupled to an electric generator. In some embodiments, the range extender 109 may provide electrical energy to the energy storage devices 104 when the vehicle enters an operational mode characterized by partially disabled or reduced performance and/or functionality (e.g. while operating in “limp mode” or “limp home mode”). The range extender 109 can provide electrical energy to electric energy storage devices 104 in operational situations that require energy usage levels falling outside historic and/or predicted operational demands of individual electric vehicles. Such situations are referred to herein as “edge cases”.

Advantageously, the discrete electric energy storage devices 104 are low storage capacity, rapid recharge, high cycle life electric energy storage devices. Examples of such devices include, but are not limited to, supercapacitor power packs, which act as the vocational vehicle's power source. In such power packs, a plurality of supercapacitors are used to store energy and provide power to the drivetrain of the vocational vehicle, as well as the integral equipment and the peripheral equipment of the vocational vehicle.

While most known electric vehicle systems use lithium-ion batteries, the present inventors have recognized that in certain applications, it is advantageous to rely on an electric energy storage device characterized by relatively low storage capacity, and with relatively rapid discharge-recharge times but high cycle life, compared to currently available lithium-ion batteries. Currently, Electric Double Layer Capacitors (aka EDLCs, or ultracapacitors, or super-capacitors), are available that meet these characteristics.

Suitable electric energy storage devices 104 selected for vocational vehicles may have an energy storage capacity between about 1 to 5 kWh, which should be sufficient to operate most integral (including the drivetrain) and peripheral equipment. Such electric energy storage devices 104 should also have a high power capacity to allow powering of equipment rated at something in the order of 10-50 kW, and also allowing them to be recharged quickly, advantageously in less than one minute. Such electric energy storage devices 104 should also have a lifespan in excess of about one million cycles to remain operational for a vehicle life expectancy of 10 years. For example, unlike a lithium-ion battery, ultracapacitors can readily go through hundreds of discharge and recharge cycles in a day, while still being expected to maintain full functionality throughout the life of the vehicle.

In addition, electric energy storage devices 104 should also be compatible with the environmental variables of the specific vocational vehicle, including operating temperature range, corrosion resistance and vibration resistance. Indeed, the use of ultracapacitor power packs is particularly advantageous in vocational vehicles because of their ruggedness, high cycle life, and resistance to temperature fluctuations.

Moreover, given that ultracapacitors can sustain charge-discharge cycles in excess of one million cycles, the energy storage capacity can be reduced to as low as the energy required to perform one operation cycle of the equipment of the vocational vehicle and travel to the next charging point in the energy distribution system. The size of the energy storage capacity can thus be reduced by a factor of close to one hundred compared to systems powered by lithium-ion batteries. Consequently, the use of low storage capacity, rapid recharge, high cycle life electric energy storage devices as electric energy storage devices 104 allows the wireless charging unit 109 onboard the vocational vehicle to be smaller, lighter and less expensive than a system that relies on lithium-ion batteries.

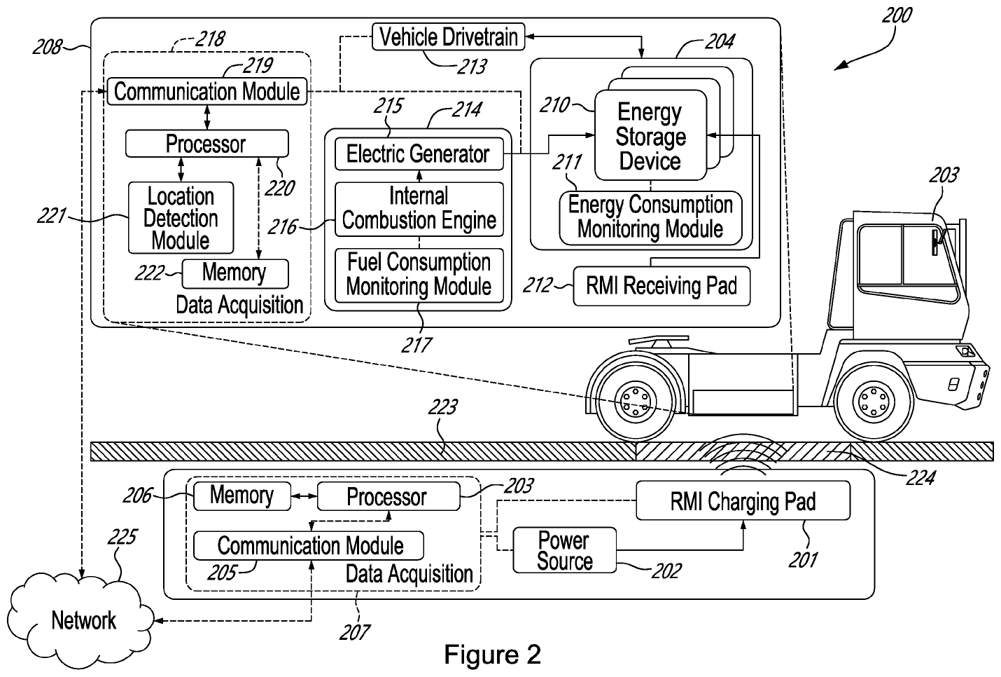

FIG. 2 is a more detailed schematic diagram of functional components used by energy distribution system 200 in accordance with the present disclosure. As described above, energy distribution system 200 comprises two main components, namely a wirelessly chargeable unit 204 located on a vocational vehicle 203, as well as a wireless charging point. As described above, in some embodiments, the wireless charging point comprises a Resonant Magnetic Induction (RMI) transmitter pad 201 and a power source 202. Similarly, the onboard energy distribution components 208 of vocational vehicle 203 include a wireless chargeable unit 204 that is made up of an RMI receiver pad 212 and a scalable bank of electric energy storage devices 210. Each electric energy storage device 210 can be recharged using the electricity produced by the RMI receiver pad 212.

The wireless charging point and onboard energy distribution components 208 include data acquisition modules 207, 218, respectively. In the example shown in FIG. 2, each data acquisition module 207, 218 includes a processor 203, 220, a memory 206, 222 and a communication module 205, 219 configured to communicate with network 225. Network 225 may be a data communications network such as the Internet, and communication thereto/therefrom can be provided over a wired connection and/or a wireless connection (e.g., WiFi, WiMAX, cellular, etc.).

Processors 203, 220 of data acquisition modules 207, 218 comprise one or more processors for performing processing operations that implement functionality of the data acquisition modules 207, 218. A processor of processors 203, 220 may be a general-purpose processor executing program code stored in memory 204, 222 to which is has access. Alternatively, a processor of the processors 203, 220 may be a specific-purpose processor comprising one or more preprogrammed hardware or firmware elements (e.g., application-specific integrated circuits (ASICs), electrically erasable programmable read-only memories (EEPROMs), etc.) or other related elements.

Memory 204, 222 comprise one or more memories for storing program code executed by processors 203, 220 and/or data used during operation of processors 203, 220. A memory of memory 204, 222 may be a semiconductor medium (including, for example, a solid-state memory), a magnetic storage medium, an optical storage medium, and/or any other suitable type of memory. A memory of memory 204, 222 may be read-only memory (ROM) and/or random-access memory (RAM), for example.

In some embodiments, two or more elements of processors 203, 220 may be implemented by devices that are physically distinct from one another and may be connected to one another via a bus (e.g. one or more electrical conductors or any other suitable bus) or via a communication link which may be wired. In other embodiments, two or more elements of processors 203, 220 may be implemented by a single integrated device. As will be appreciated by the skilled reader, the hardware and software components of data acquisition modules 207, 218 may be implemented in any other suitable way in other embodiments.

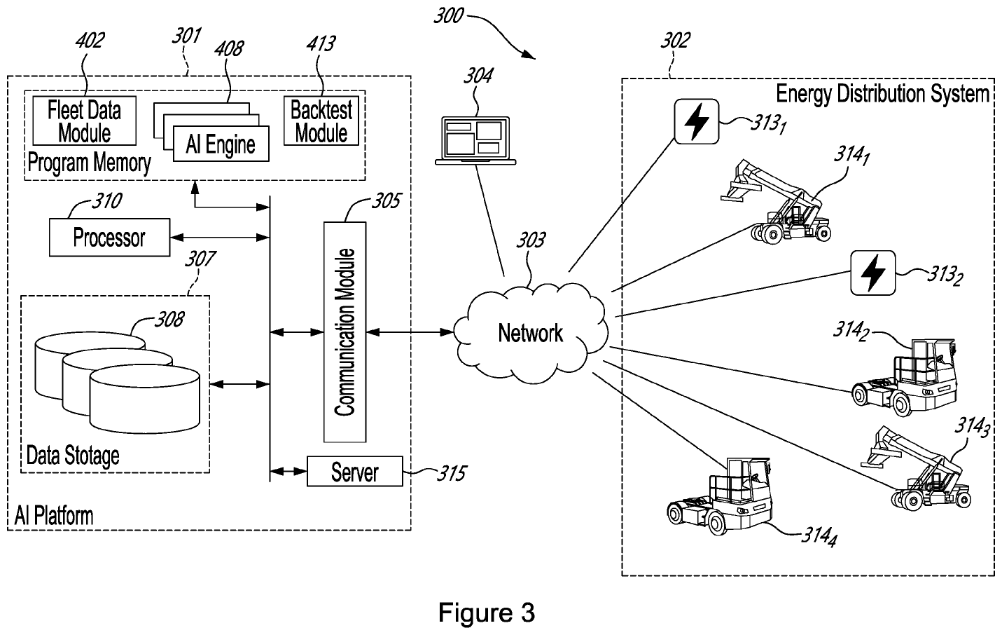

In the example shown in FIG. 2, the main purpose of communicating with network 225 is so that data acquisition modules 207, 218 can provide operational and positional data to the data processing, storage and analytics elements of the system (as described in more detail below with reference to FIG. 3), via network 225. In most cases, the communication modules 205, 219 are remote from the data processing, storage and analytics elements of the system, and thus communication between these components of the energy distribution system is carried out indirectly, e.g. through one or more networks and/or one or more additional communication devices.

For example, in some embodiments, the communication modules 205, 219 may communicate with a WiFi hotspot or cellular base station, which may provide access to a service provider and ultimately the Internet (or other similar network), thereby allowing data acquisition modules 207, 218 to communicate with the data processing, storage and analytic elements of AI platform 301, as described in more detail herein. As another example, in some embodiments, communication between data acquisition modules 207 and 218 and the AI platform 301 may take place through a smartphone, tablet, head-mounted display, or other communication device which is carried or worn by the user of the vocational vehicle and which itself may have established communication with a WiFi hotspot or cellular base station.

In some embodiments, the onboard energy distribution components 208 also include an electric drivetrain 213 of the vocational vehicle 203. Other elements which may constitute parts of an electric vocational vehicle's drivetrain will be apparent to those skilled in the art.

In some embodiments, the onboard energy distribution components 208 can include further powertrain elements (not shown) for connecting the bank of electric energy storage devices 210 to integral and peripheral equipment of the vocational vehicle 203.

In some embodiments, the onboard energy distribution components 208 also comprises a fuel-based range extender 214, also known as a fuel-based Auxiliary Power Unit (APU), configured to recharge the bank of electric energy storage devices 210. In particular, range extender 214 is configured to extend the range of vocational vehicle 203 by using an internal combustion engine 216 to drive an electric generator 215 that in turns charges the bank of electric energy storage devices 210. As will be appreciated by the skilled reader, range extender 214 can be powered using any suitable type of fuel, including, but not limited to propane, butane, ethanol, gasoline, diesel, natural gas, hydrogen, acetylene, as well as mixtures thereof. As described in more detail herein, the range extender 214 can, in addition or alternatively, comprise a high energy, slow charging, low cycle energy storage device, or other suitable source of electric energy.

In some embodiments, energy consumption monitoring module 211 forms part of the wirelessly chargeable unit 209 and is configured to collect operational information relating to the energy storage devices 104. Examples of such information include the amount of electricity used by each energy storage device 104, the utilization of each energy storage device 104 (that is to say the average amount of charge stored and dispensed in each recharge cycle), the amount of time in a given time period spent charging, the average peak output power during a given time period, the amount of time in a given time period spent at peak power output, and charging efficiency information. The operational information relating to the energy storage devices 104 is then sent to data acquisition module 218 for subsequent use, as described in more detail herein.

Similarly, in some embodiments, data acquisition module 207 is configured to collect operational information relating to the wireless charging point. Examples of such information include customer/vehicle identification information to prevent unauthorized use of the wireless charging point, charging efficiency information, information relating to how well a vehicle is aligned on the wireless charging point during a charging event, etc.

In some embodiments, fuel consumption monitoring module 217 forms part of the wireless chargeable unit 209 and is configured to collect operational information relating to the range extender 214. Examples of such information include various fuel/energy consumption statistics. The operational information relating to the range extender 214 is then sent to data acquisition module 218 for subsequent use, as described in more detail herein.

In some embodiments, other information, including diagnostic information, relating to the vocational vehicle 205 may be collected by way of directly or indirectly connecting the vocational vehicles vehicle bus (not shown) to data acquisition module 218. An example of such a vehicle bus is the Society of Automotive Engineers' standard SAE J1939, which is widely used by diesel engine manufacturers.

Location detection module 221 may be connected to, or form part of, data acquisition module 218. Location detection module 221 is configured to determine the physical location of a vehicle over time, and may be implemented using any known technology, including, but not limited, to Global Positioning System (GPS), WiFi positioning systems (WPS), Near Field Communication (NFC), Radio-Frequency Identification (RFID), Bluetooth Low Energy (BLE) beacons, Quick Response (QR) codes. As will be appreciated by the skilled reader, any other suitable technology may be used. As will be appreciated by the skilled reader, once the physical location of a vehicle is established over a period of time with sufficient granularity, it is possible to determine not only the route of the vocational vehicle, but also the speed and acceleration of the vocational vehicle, as well as the time a vocational vehicle spends at particular locations, each of which can be determined by the systems and methods disclosed herein.

As will be described in more detail below, during the initial use of the systems and methods described herein, some or all of the vehicles in a fleet may be fuel-based vocational vehicles. That is to say that, prior to the electrification of a site, the systems and methods described herein may be configured to collect vocational vehicle information in order to establish an initial energy distribution system. In such instances, vocational vehicle information can include positional information provided by a location detection module 221, as well as vehicle bus information received from a SAE J1939 connection.

FIG. 3 is a schematic diagram of an example of a system 300 in accordance with the present disclosure. The system 300 includes an energy distribution system 302 (as described above in various embodiments) connected, via a network 303, to the AI platform 301. Network 303 may be a data communications network such as the Internet, and communication thereto/therefrom can be provided over a wired connection and/or a wireless connection (e.g. WiFi, WiMAX, cellular, etc.). The system 300 may also comprise communication devices 304 configured to implement User Interfaces (UIs) for allowing users to monitor the performance of the energy distribution system 302, as well as to interact with the AI platform 301 in such a way as to provide system constraints in relating to the progressive electrification of a site.

As described in more detail above, in some embodiments, the energy distribution system 302 includes one or more vocational vehicles 314ₓ, as well as one or more charging stations 313ₓ, each of which is in data communication with network 303.

In some embodiments, the AI platform 301 shown in FIG. 3 is implemented in a single location. In other embodiments however, the AI platform 301 is distributed across a range of networked computing devices located in different physical locations. For example, the program memory 311 containing Artificial Intelligence (AI) models and the processor 310 (or processors) capable of using data to train the AI models and use the AI models to determine appropriate energy distribution system design (as described in more detail herein), can form part of a cloud computing system. The structured data collected by the vocational vehicles 314ₓ and the charging stations 313ₓ, however, may be stored in a data storage facility in a separated location. Similarly, the server 315 or servers used by the system to provide information to users via communication devices 304 may also be located in different locations.

In some embodiments, the AI platform 301 includes one or more communication modules 305 that may communicate via a wired connection or wireless connection to a Local Area Network (LAN) and/or the Internet.

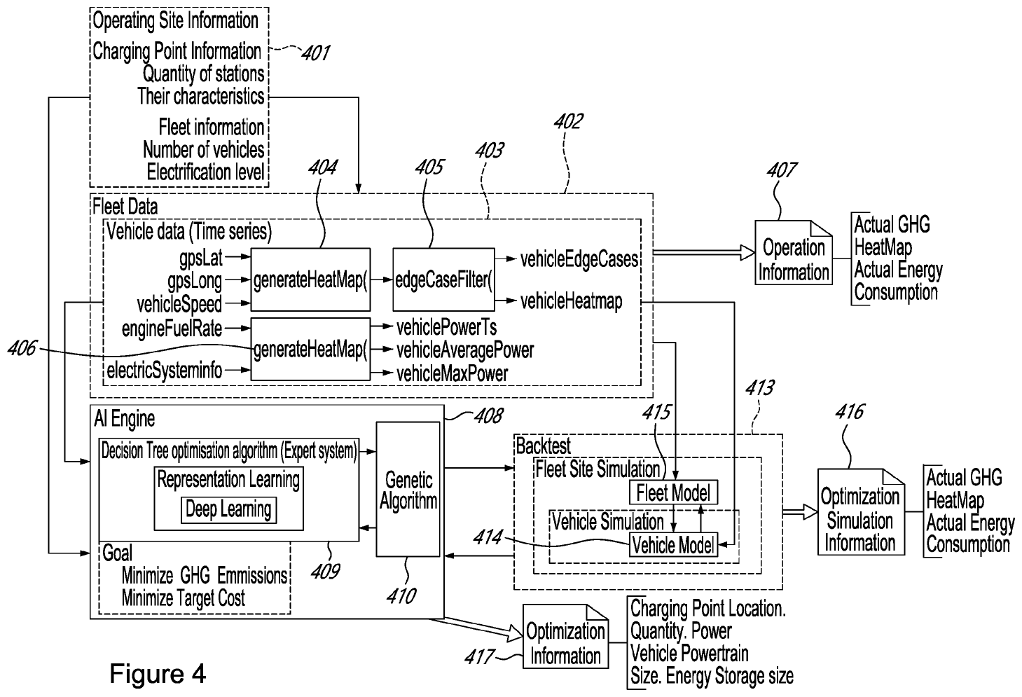

The AI platform 301 may also include a processor 310, program memory and one or more data storage devices 308. Processor 310 may comprise one or more processors for performing processing operations that implement functionality of the various methods described herein with reference to FIGS. 4 to 10. Processor 310 may be a general-purpose processor executing program code stored in program memory.

Program memory comprises one or more memories for storing program code executed by processor 310, data used during operation of processor 310, a fleet data module 402, a backtest module 413, as well as one or more AI engines 408. Memory 311 may be a semiconductor medium (including, e.g., a solid-state memory), a magnetic storage medium, an optical storage medium, and/or any other suitable type of memory. AI Engine 408 may include one or more AI models, as described in more detail herein.

In some embodiments, two or more elements of processor 310 may be implemented by devices that are physically distinct from one another and may be connected to one another via a bus (e.g. one or more electrical conductors or any other suitable bus) or via a communication link which may be wired. As will be appreciated by the skilled reader, the hardware components of the AI platform 301 may be implemented in any suitable way in order to implement the methods disclosed herein.

FIG. 4 is a schematic block diagram of an example method carried out by the system of FIG. 3. The method may begin with site information 401 being received by the AI platform 301 from the energy distribution system 302 or, prior to an energy distribution system being put in place, from vehicles operating on a particular site upon which an energy distribution system is to be provided. As described in more detail herein, in some embodiments, the site information 401 may include the number of vehicles operating on a site, the number and location of charging points, as well as any other relevant information relating to vehicles operating on the site and/or charging stations provided on the site. Such information may include, but is not limited to, vehicle positional information including vehicle positions over time, vehicle speeds, vehicle accelerations, vehicle fuel consumption, vehicle electricity consumption, electric energy storage device information such as capacity utilization information, charging point information including charging point location, charging point utilization information over time, peak charging point usage, etc. As will be appreciated by a skilled person, any other information required to carry out the systems and methods disclosed herein may be present in the received site information 401.

The site information 401 received by the system may be used by fleet data module 402 to carry out some data preprocessing, prior to use by the AI engine 408. In some embodiments, this preprocessing can be implemented by a vehicle data module 403 that is configured to use some or all of site information 401 to generate vehicle-related insights which will then be used by AI engine 408, as well as backtest module 413. An example of vehicle-related insights may include, but is not limited to, the generation of a vehicle heatmap for the site, including the identification of activities (i.e. “edge cases”) during which vehicles may be operating under conditions or in areas that should either not be considered or should be considered differently by the AI engine 408. For example, an edge case may exist for a vehicle which needs to travel to an unexpected location on the site for an unexpected period of time (e.g. for maintenance).

As defined herein, the term “heatmap” may refer to one or more data visualizations showing the magnitude of a phenomenon in a particular location and/or the underlying information required to produce such data visualizations. Another example of vehicle-related insights may include information relating to the fuel and electric power consumption over time.

In the specific example shown in FIG. 4, the generateHeatMap module 404 and edgeCaseFilter module 405 use GPS latitude information, GPS longitude information and vehicle speed information relating to one or more of vehicles 314ₓ to identify vehicle edge cases and to generate a vehicle heatmap. The getVehiclePower module 406 uses engine fuel consumption information produced by fuel consumption monitoring module 217 and the electric system information produced by energy consumption monitoring module 211 to generate vehicle power information including, but not limited to, average vehicle power usage information, maximum vehicle power usage information.

Once produced, vehicle-related insights calculated by the fleet data module may subsequently be used by AI engine 408 and backtest module 413, as described in more detail herein. In some embodiments, the vehicle-related insights may also be included in an operation information 407, which may include any information describing or related to the current operating conditions on a given site. In some embodiments, the operation information 407 may be produced in the form of a report. In some embodiments, the operation information 407 may be presented to a user of the system on a User Interface (UI), as described in more detail herein. In some examples, on a site where the energy distribution system does not yet comprise a wireless charging point 206 or onboard energy distribution components 208 (e.g. on a site destined for electrification, but currently operating fuel-powered vehicles), the operation information 407 may include actual Greenhouse Gas (GHG) emissions, a heatmap of vehicle activity and usage. In other examples in which the process of electrification has commenced, any other information relating to the current status of the energy distribution system may be included in operation information 407.

As shown in FIG. 4, site information 401 is also used directly by AI engine 408 in order to generate optimization information 417. Optimization information 417 includes information describing proposed changes to the energy distribution system 302 that are designed to maximize the reduction of greenhouse gas emissions (i.e. maximize the utilization of energy storage devices 210), while at the same time minimizing the number of charging points 206 required. In some embodiments, the AI engine 408 can factor in one or more predetermined further energy distribution system constraints in producing the optimization information 417. Energy distribution system constraints may include, but are not limited to, the capital expenditure required to carry out the proposed changes, limitations relating to the number of energy distribution system elements (e.g. supercapacitor power packs) available to carry out the proposed changes, a minimum or maximum target proportion of site electrification, a minimum or maximum GHG emission reduction target.

Accordingly, a user may, by way of the UI of communication device 304, use the AI platform 301 to determine a number of likely effects caused by various proposed changes. For example, a user may wish to know the capital expenditure required to arrive at a given proportion of site electrification (e.g. the financial investment required to arrive at 87% of site energy being electric). Alternatively, or additionally, a user may wish to know the capital expenditure required to arrive at a given reduction in GHG emissions over a period of time (e.g. the financial investment required to reduce GHG emissions by 1.2 metric tons per year). Alternatively, or additionally, a user may wish to know the change in the proportion of site electrification given an addition of new energy distribution system elements (e.g. adding two supercapacitor storage devices to a particular vehicle in the current energy distribution system will increase site electrification proportion by 1.6%). Alternatively, or additionally, a user may wish to know the change in the overall reduction of GHG emissions given the addition of new energy distribution system elements. Alternatively, or additionally, a user may wish to know the Return on Investment (ROI) per additional energy distribution system element (e.g. energy storage device 104 or wireless charging point).

The skilled reader will understand that the AI platform described herein may be used in any number of other ways to produce insights into the design and incremental electrification of a site.

Moreover, the systems and methods disclosed herein allow users not only to comprehensively assess the greenhouse gas emission reductions and cost savings of electrification, but to predict, with a high degree of accuracy, the likely greenhouse gas emission reductions and the likely cost savings of each incremental steps in the electrification process of a site. As will be appreciated by the skilled reader, as the size of the electrification project increases (e.g. the number of vehicles, the number of electric energy storage devices and the number of charging points), so will the number of incremental steps possible. Thus, these accurate and granular predictions allow users to progressively implement the process of electrification without undue technical and financial burdens, thereby significantly lowering the risks involved with such projects. In other words, the systems and methods disclosed herein allow users to carry out the process of electrification with high degrees of predictability and control.

As such, the predictability and control over the electrification process afforded by the present invention allows for such new energy provisioning models as “energy as a service”, in which vehicle fleet owner/operators pay a monthly fee to a third party for the provisioning of energy to their fleet, without the need to purchase the energy distribution system components provided by the third party. Such energy provisioning models would also see the energy distribution system provided by the third party as being dynamically adaptable to the changing needs of the fleet.

Various examples of optimization information 417 will be described in more detail herein below. In some embodiments, the optimization information 417 may be produced in the form of a report. In some embodiments, the optimization information 417 may be presented to a user of the system on a user interface, as described in more detail herein.

Elements of optimization information 417 are generated by AI engine 408. In some advantageous embodiments, AI engine 408 uses one or more expert system decision tree models comprising logical rules that have been created by an expert, such as an engineer or technician. For example, there may be a minimum distance that must be provided between two charging points, or it may not be appropriate to locate charging points in certain zones within a site. In some advantageous embodiments, the decision tree models describe herein may be implemented using feature learning, also known as representation learning. In the example described with reference to FIG. 4, the decision tree models are one or more Classification and Regression Tree (CART) models implemented using multi-layered neural networks.

In some embodiments, the decision tree models described herein are initial built/trained by processes known as “induction” and “pruning”. The first step is that of collecting a training data set from site information 401 and vehicle-related insights and determining the features upon which the data set will be split. In some examples, the step of determining upon which features the data set will be split is performed with input from an expert. In other examples, the step of determining upon which features the data set will be split is performed without input from an expert. In yet other examples, some features are selected with input from an expert and some features are selected without input from an expert. The data set is then split into subsets that include possible values for each selected feature. Finally, new tree nodes are produced by regressively splitting the data set into new subsets and verifying accuracy. Once induced, the effect of “pruning” a node in the decision tree can be calculated for each node individually. Nodes having an effect on accuracy which are below a certain threshold can be removed or “pruned”.

Once created, the decision tree models used by AI engine 408 are optimized using decision tree optimization algorithm module 409, which is coupled to a genetic algorithm 410. In some embodiments, the genetic algorithm module 410 receives backtest results from backtest module 413. As will be described in more detail below, the backtest results received from the backtest module 413 provide an indication of how well one or more decision tree models are able to simulate the operation of a energy distribution system 302. By iteratively adjusting the parameters of the decision tree and receiving backtest information from the backtest module 413, the genetic algorithm module 410 effectively promotes the use of relatively successful decision tree models and impedes the use of relatively unsuccessful decision tree models by AI engine 408.

While the use of decision trees is particularly advantageous to the applications described herein, the AI engine 408 of the AI platform 301 described herein may instead of (or together with) use other AI models including, but not limited to, linear regression models, logistic regression models, linear discriminant analysis models, naïve Bayes classifiers, K-nearest neighbors classifiers, learning vector quantization models, support vector machines, bagging and random forest models and deep neural networks.

Backtest module 413 is configured to test the accuracy of the predictive models generated by AI engine 408 using historical data. In particular, in some embodiments, the backtest module 413 is configured to simulate the behavior of the fleet, by way of the fleet model 415, as well as the behavior of individual vehicles, by way of the vehicle model 414.

In some embodiments, the backtest module 413 is configured to produce optimization simulation information 416. In some examples, the optimization simulation information 416 may be produced in the form of a report. In some examples, the optimization simulation information 416 may be presented to a user of the system on a UI, as described in more detail herein. In some examples, the optimization simulation information 416 may include an indication of the actual GHG emissions compared to the GHG emissions predicted by the AI engine 408 over a specific period of time. In other examples, the optimization simulation information 416 may also include a comparison of a predicted heatmap and a heatmap generated using site information 401 and/or a comparison of predicted energy consumption and energy consumption values contained in site information 401 and/or calculated by fleet data module 402.

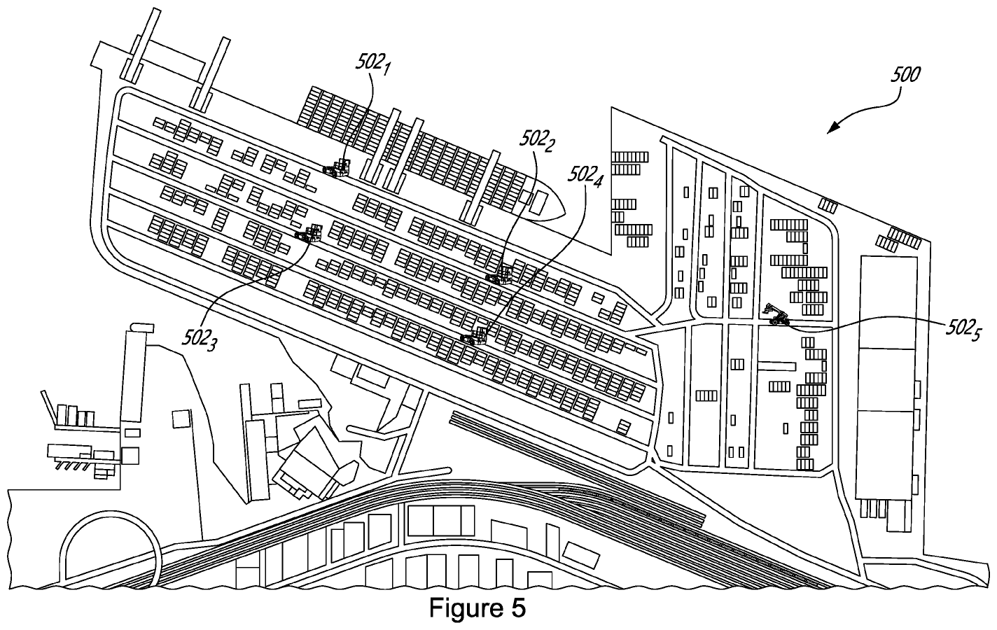

FIG. 5 is an illustration from an aerial perspective of a site 500 which can be provided with wireless energy distribution systems by systems and methods disclosed herein. In the example shown in FIG. 5, the site 500 is an area of an industrial port and comprises a number of buildings or immovable structures 501, as well as roads (or otherwise drivable) surfaces upon which travel vocational vehicles 502 carrying out particular tasks on site 500. As will be appreciated by the skilled reader, the system and methods described herein are independent of the characteristics of site 500. Examples of site 500 include, but are not limited to, industrial ports, train yards, power generation facilities, storage facilities, sorting facilities, manufacturing sites, construction sites and zones, neighborhoods or cities serviced by various forms of vocational fleets.

In the example shown, site 500 is used by a number of vocational vehicles 502ₓ, including four trucks 502₁, 504₂, 502₃, 502₄, (e.g. terminal tractors) which may be used for transporting containers short distances from ships to rail terminals or drayage trucks, for example. Site 500 is also used by a stacker 502₅ (also known as a reach stacker) which may be used for handling intermodal cargo containers at site 500. In the example of FIG. 5, site 500 is used by fuel-powered vocational vehicles 502ₓ, each of which is capable of collecting positional information over time and fuel-consumption information over time. When a site operator and/or fleet operator requires electrification of site 500, the methods and systems disclosed herein can be used to better understand the operational conditions of site 500, as will now be described in more detail.

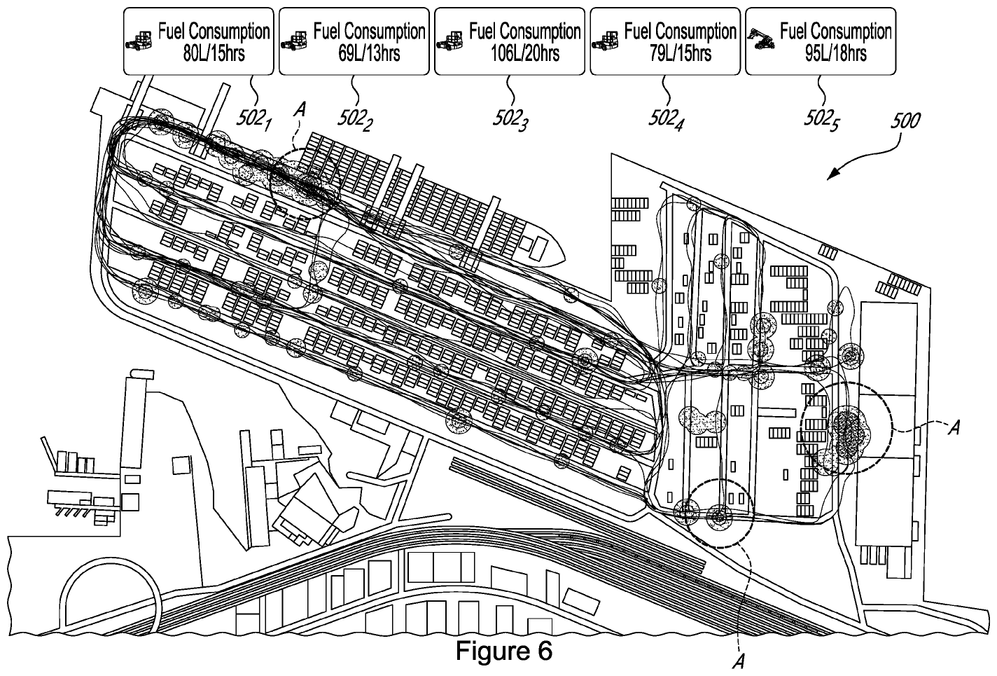

FIG. 6 shows an example output of fleet data module 402. The example output of FIG. 6 may form part of the operation information 407 and/or may be presented to a user on a UI of communication device 304. FIG. 6 represents a vocational vehicle heatmap containing a visualization showing the magnitude of vocational vehicle presence in particular locations around site 500 over a period. A defined herein, a “period” is any duration of time that may be set either by the system and methods described herein or by a user of the system and methods described herein. Examples of periods include, but are not limited to, one day, one week, one month and one year. In the example of FIG. 6, the period is one day. That is to say that the heatmap represents a visualization of the time vehicles spend in particular locations over the course of one day.

In the example of FIG. 6, the heatmap clearly shows that vocational vehicles 502ₓ spend a large amount of time in areas “A”. Another piece of information which may be provided in operation information 407 is the fuel consumed by each vehicle over a period of time.

As shown in FIG. 6, operation information 407 also comprises an indication of total fuel (e.g. diesel) consumption per vocational vehicle 502ₓ over the period. In particular, vocational vehicle 502₁ consumed 80 liters of fuel in a 15-hour period, vocational vehicle 502₂ consumed 69 liters of fuel in a 13-hour period, vocational vehicle 502₃ consumed 106 liters of fuel in a 20-hour period, vocational vehicle 502₄ consumed 79 liters of fuel in a 15-hour period and vocational vehicle 502₅ consumed 95 liters of fuel in an 18-hour period.

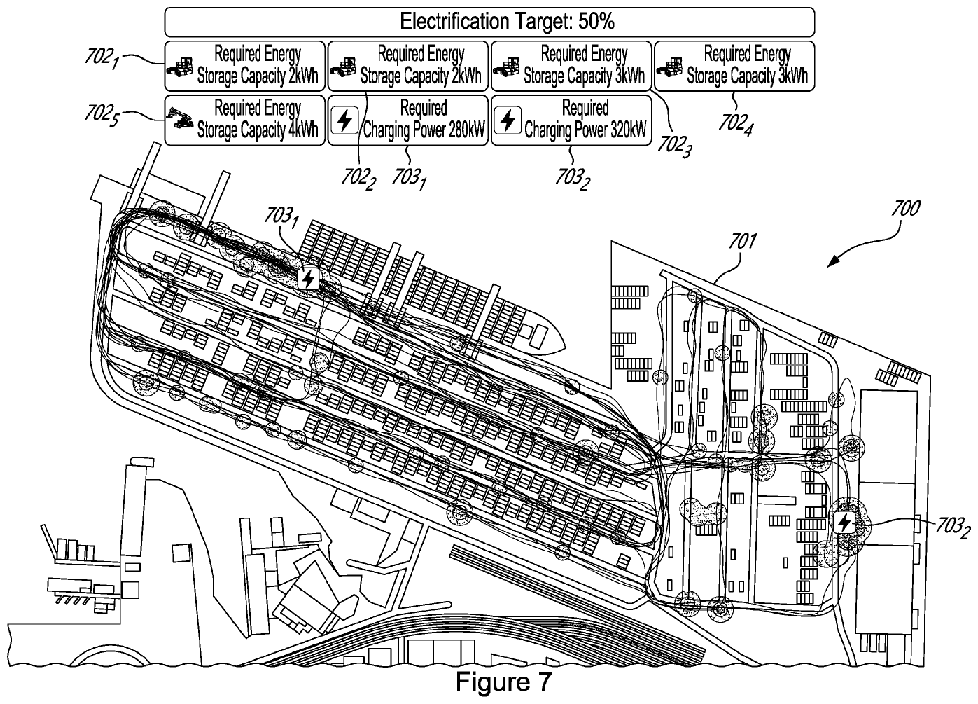

FIG. 7 is an illustration from an aerial perspective of an example wireless energy distribution system provided by AI engine 408 of the systems and methods disclosed herein. In particular, FIG. 7 shows an energy distribution system that benefits from a certain proportion of electrification (i.e. 50%) on site 701, that is to say that 50% of energy used by the vehicles 702ₓ in a fleet on site 701 comes from an electric source. In the example shown in FIG. 7, the AI engine 408 has determined the optimal position of charging points 703ₓ that will maximize the utilization of the energy distribution system's energy storage devices 210, while at the same time minimizing the number of charging points required.

In the example of FIG. 7, the AI engine 408 has produced optimization information 417 that contains a recommendation to add two charging points 703₁ and 703₂ at the specific locations shown, and to set the energy storage capacity of vehicle 702₁ to 2 kWh, the energy storage capacity of vehicle 702₂ to 2 kWh, the energy storage capacity of vehicle 702₃ to 3 kWh, the energy storage capacity of vehicle 702₄ to 3 kWh and the energy storage capacity of vehicle 702₅ to 4 kWh.

The relatively low proportion of electrification (e.g. 50%) in the example of FIG. 7 may be a result of further energy distribution system constraints. For example, the AI engine 408 may have been configured to provide optimization information 417 taking into consideration that any proposed changes should not exceed a certain amount of capital expenditure and/or that only two charging points can be sourced for the project.

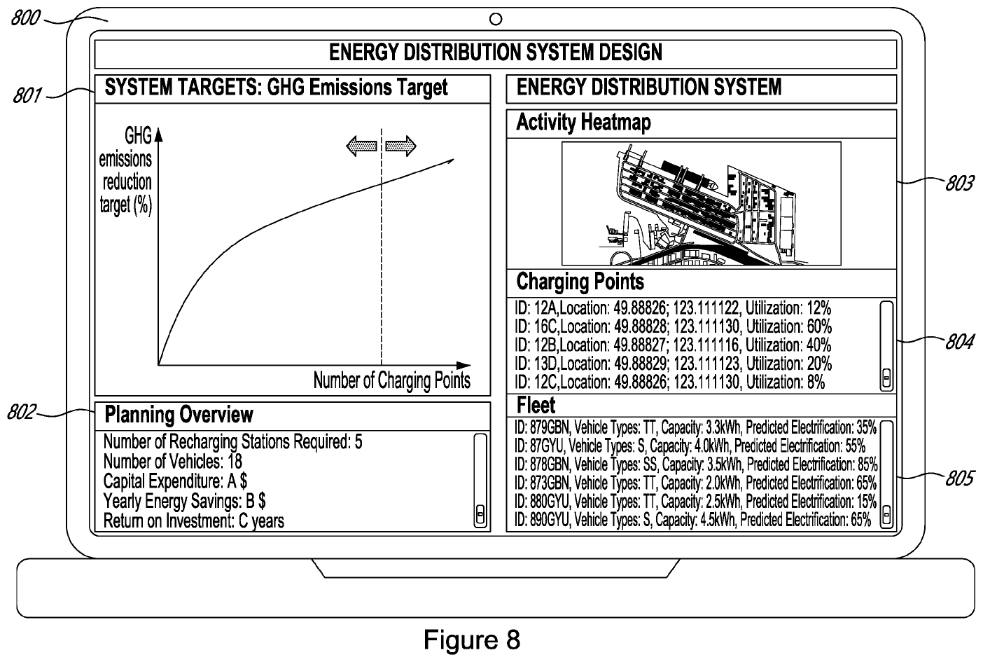

FIG. 8 is an illustration of an example User Interface (UI) that can be provided to users of the systems and methods described herein. Example users of the systems and methods disclosed herein include, but are not limited to, fleet owners/operators, site owners/operators and energy distribution system providers. While the UI 800 of FIG. 8 is shown presented on a laptop computer, it may also (or instead) be presented on other suitable communication device such as, but not limited to, a smartphone, a tablet or other communication device which is carried or worn by a user of the system.

In some embodiments, the UI 800 is configured to provide users of the system with visual representations of real-time performance information relating to the energy distribution system, such as operation information 407 and/or information setting out what changes could be made to the system in order to achieve particular targets, such as optimization information 417. In some embodiments, the UI 800 is configured to provide users of the system with AI engine 408 performance information, such as optimization simulation information 416. AI engine 408 performance information will be particularly relevant to energy distribution system providers.

In the specific example shown in FIG. 8, the UI 800 is composed of five distinct sections 801, 802, 803, 804 and 805. A system targets section 801 allows a user to set targets for the future step of the electrification process. In some embodiments, the system targets section 801 includes a graph plotting the effect of adding individual charging points on GHG emissions reduction targets. A movable user interface element (a dotted line that can be dragged to the left or right in FIG. 8) allows a user to increase/decrease the number of charging points in the proposed energy distribution system associated with the next incremental step of electrification (e.g. “phase 3”, which may relate to a set of proposals outlined in optimization information 417). The corresponding effect on the GHG emissions reduction target can be seen in on the graph in system targets section 801, and the overall effect on the proposed energy distribution system can be seen in charging points section 804 and fleet section 805.

Planning overview section 802 provides a user with an overview of the number of charging points required, the number of vehicles that are to use the energy distribution system, the projected capital expenditure required to implement the proposed electrification step, the yearly energy savings provided by the proposed electrification step and the return on investment (in years) associated with the proposed electrification step.

The activity heatmap section 803 shows current, past or simulated heatmaps of vehicle activity on site 500. As will also be appreciated by the skilled reader, other information relating to vehicle activity can also or instead be displayed as part of UI 800. Moreover, other heatmaps may additionally, or alternatively, form part of UI 800. For example, UI 800 may comprise a GHG emissions heatmap showing current or predicted levels of GHG emissions as they occur (or are predicted to occur) over a given site.

The charging point section 804 shows information relating to current or proposed individual charging points, including charging point identification information, charging point location information and charging point utilization information. In some embodiments, the charging point section 804 may also include the number of charging events per period of time (e.g. the number of times in a day that a vehicle used the charging point), the utilization of the charging point over a period of time (e.g. the number of minutes in a day that the charging point spend charging one or more energy storage devices) and peak power output during a charging period (e.g. the maximum power output of the charging point during a time period). As will be appreciated by the skilled reader, any other information relating to the current, past or future performance of the charging points related to a current or proposed energy distribution system can be displayed as part of UI 800.

The fleet section 805 shows relating to current or proposed individual fleet vehicles, including vehicle identification information, vehicle type information, energy storage capacity information, and predicted electrification information (e.g. the amount of electric energy used by a vehicle as a proportion of its total energy usage). In some embodiments, the fleet section 805 may also include vehicle energy usage over a time period, fuel consumption over a time period, and predicted GHG emission reductions for that vehicle over a time period resulting from electrification steps proposed by AI engine 408 and subsequently carried out. As will be appreciated by the skilled reader, any other information relating to the current, past or future performance of the fleet or individual vehicles in a fleet can be displayed as part of UI 800.

As will also be appreciated by the skilled reader, any other information relating to the current, past or future performance of the energy distribution system can be displayed as part of UI 800.

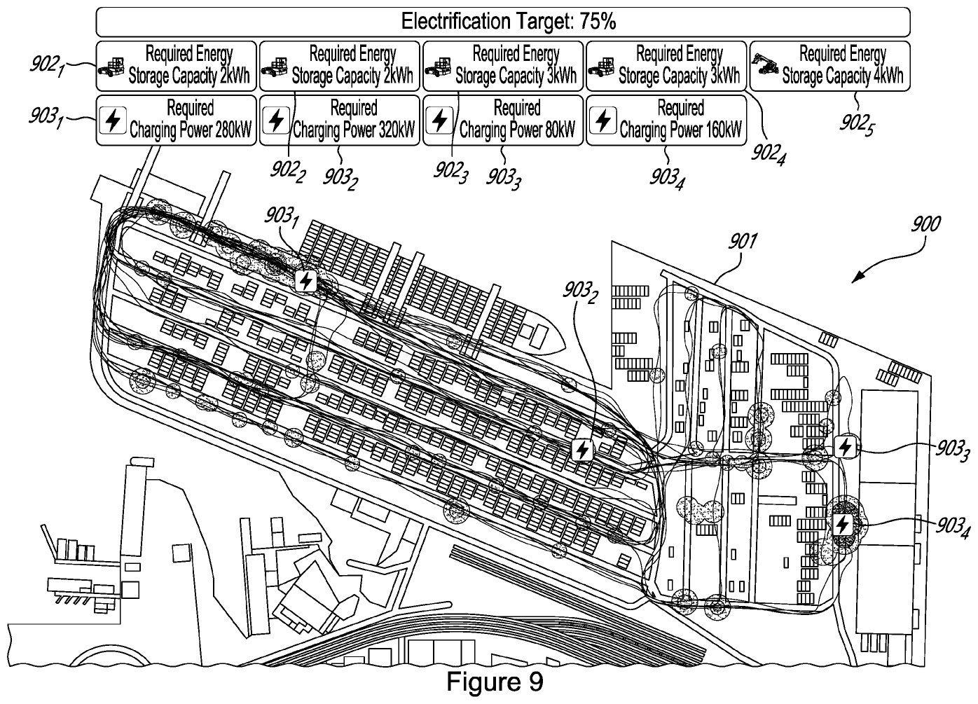

FIG. 9 is an illustration from an aerial perspective of an example wireless energy distribution system provided by AI engine 408 of the systems and methods disclosed herein. In particular, FIG. 9 shows an energy distribution system that benefits from a certain proportion of electrification (e.g. 75%) on site 901, that is to say that 75% of energy used by the vehicles 902ₓ in a fleet on site 901 comes from an electrical source. In the example shown in FIG. 9, the AI engine 408 has determined the optimal position of charging points 903ₓ that will maximize the utilization of the energy distribution system's energy storage devices 210, while at the same time minimizing the number of charging points required.

In the example of FIG. 9, the AI engine 408 has produced optimization information 417 that contains a recommendation to add four charging points 903₁, 903₂, 903₃ and 903₄ at the specific locations shown, and to set the energy storage capacity of vehicle 902₁ to 2 kWh, the energy storage capacity of vehicle 902₂ to 2 kWh, the energy storage capacity of vehicle 902₃ to 3 kWh and the energy storage capacity of vehicle 902₄ to 3 kWh. The relatively high proportion of electrification (e.g. 75%) in the example of FIG. 9 may be a result of relatively fewer energy distribution system constraints (e.g. compared to the example shown in FIG. 7). For example, the AI engine 408 may have been configured to provide optimization information 417 within the constraint that any proposed changes should not exceed a larger amount of capital expenditure than that provided in the example of FIG. 7.

As will be appreciated by the skilled reader, the fewer further energy distribution system constraints are provided to the AI engine 408, the higher the proportion of electrification that can be attained. This allows users to progressively and iteratively achieve higher proportions of electrification as financial, supply chain and/or other energy distribution system constraints are removed. In some situations, users may which to complete the process of full electrification, either at the end of a series of progressive electrification steps (where each iteration brings the proportion of electrification higher) or, where the absence of energy distribution system constraints permit, at the very start of the process of electrification.

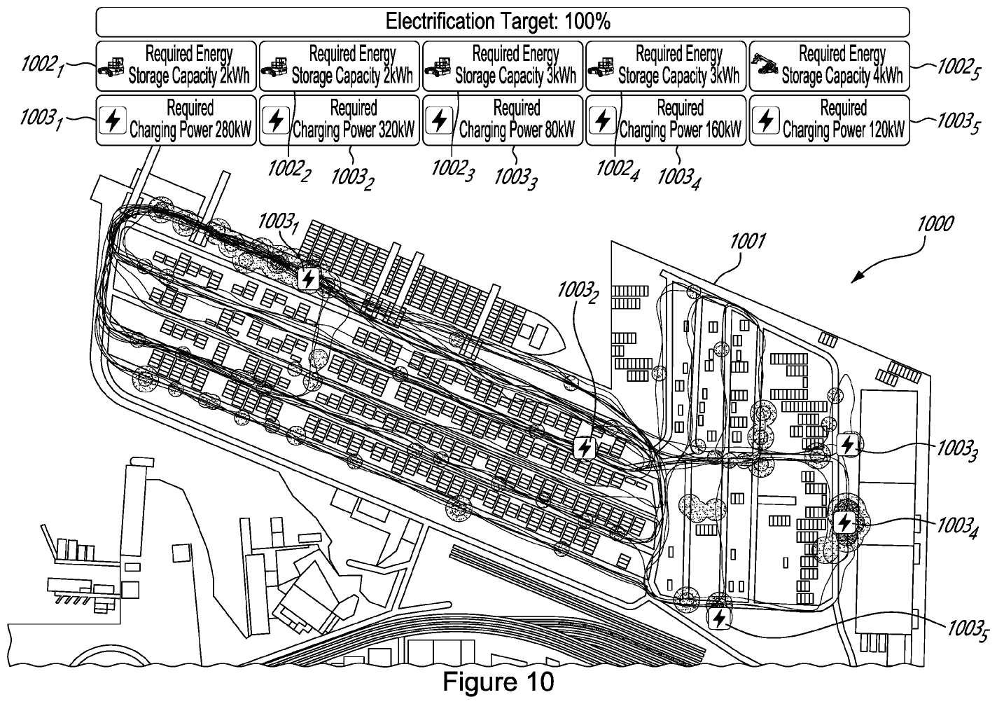

FIG. 10 is an illustration from an aerial perspective of an example wireless energy distribution system provided by AI engine 408 of the systems and methods disclosed herein. In particular, FIG. 10 shows an energy distribution system that has attained full electrification (i.e. 100%) on site 1001, that is to say that 100% of energy used by the vehicles 1002ₓ in a fleet on site 1001 comes from an electrical source. In the example shown in FIG. 10, the AI engine 408 has determined the optimal position of charging points 1003ₓ that will maximize the utilization of the energy distribution system's energy storage devices 210, while at the same time minimizing the number of charging points required.

While FIGS. 6, 7, 9 and 10 show electrification proceeding from 0% to 100% in three iterations, it will however be appreciated by the skilled reader that the number of electrification steps, and the granularity of each step can vary greatly, depending on the electrification project.

In the example of FIG. 10, the AI engine produces optimization information 417 that contains a recommendation to add five charging points 1003₁, 1003₂, 1003₃, 1003₄ and 1003₅ at the specific locations shown, and to set the energy storage capacity of vehicle 1002₁ to 2 kWh, the energy storage capacity of vehicle 1002₂ to 2 kWh, the energy storage capacity of vehicle 1002₃ to 3 kWh, the energy storage capacity of vehicle 1002₄ to 3 kWh and the energy storage capacity of vehicle 1002₅ to 4 kWh.

Full electrification, as shown in the example of FIG. 10 is a result of no, few or ineffective energy distribution system constraints. For example, the AI engine 408 may have been configured to provide optimization information 417 taking into consideration that any proposed changes should maximize GHG emission reductions, and that the proposal should not exceed a resource threshold that is significantly above the resources required to implement the proposal.

As will be appreciated by the skilled reader, all of the information shown and described above with respect to FIGS. 9 and 10 can also be presented visually to users by way of UI 800.

A person of skill in the art will readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within the scope of the appended claims. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the Figures, including any functional blocks labelled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. A system for electrification of a fleet of vehicles using an energy distribution system, the energy distribution system comprising a number of electric energy storage devices defining an electric energy storage capacity associated with each vehicle in a group of vehicles in the fleet, and a group of installed charging points, each installed charging point being associated with a location in an area, the system comprising:
a processor; and
at least one non-transitory memory containing instructions which when executed by the processor cause the system to:
receive positional information relating to a position of one or more vehicles in the fleet over time;
receive energy consumption information relating to energy consumed by the one or more vehicles in the fleet over time; and
determine, based on the received positional information, the energy consumption information, the electric energy storage capacity associated with each vehicle in the group of vehicles and the locations associated with the installed charging points of the group of installed charging points, a number of additional charging points, an optimal location within the area associated with each of the additional charging points and an optimal electric energy storage capacity associated with each of the one or more vehicles, wherein the number of additional charging points, the optimal locations associated with each of the additional charging points and the optimal electric energy storage capacities associated with the one or more vehicles are determined such that the number of additional charging points is minimized and utilizations of the optimal electric energy storage capacities are maximized.

2. The system of claim 1, wherein the instructions further cause the system to:
receive further constraint information; and
set limits on the number of additional charging points and the optimal electric energy storage capacities associated with the one or more vehicles based on the received further constraint information.

3. The system of claim 2, wherein the limits are upper limits and the constraint information includes one or more of:
a projected financial cost of providing the additional charging points;
a projected financial cost of providing the optimal electric energy storage capacities associated with the one or more vehicles;
one or more locations in the area identified as being unsuitable for a location of an additional charging point;
a maximum optimal electric energy storage capacity value associated with each of the one or more vehicles; and
a maximum value for a total number of the additional charging points and installed charging points in the area.

4. The system of claim 2, wherein the limits are lower limits and the constraint information includes one or more of:
a target value of greenhouse gas emission savings over a period of time resulting from an electrification characterized by a provisioning of the additional charging points and the optimal electric energy charging capacities associated with the one or more vehicles; and
a target electrification threshold characterized by a ratio of electric energy being used by the vehicles in the fleet to non-electric energy being used by the vehicles in the fleet over a period of time.

5. The system of claim 1, wherein one or more vehicles in the fleet has a zero kilowatt hour electric energy storage capacity.

6. The system of claim 5, wherein the group of installed charging points comprises zero charging points.

7. The system of claim 1, wherein the instructions further cause the system to determine the number of additional charging points, the optimal locations and the optimal electric energy charging capacities associated the one or more vehicles using one or more machine learning models.

8. (canceled)

9. A computer-implemented method for electrification of a fleet of vehicles using an energy distribution system, the energy distribution system comprising a number of electric energy storage devices defining an electric energy storage capacity associated with each vehicle in a group of vehicles in the fleet, and a group of installed charging points, each installed charging point being associated with a location in an area, the method comprising:
receiving positional information relating to a position of one or more vehicles in the fleet over time;
receiving energy consumption information relating to energy consumed by the one or more vehicles in the fleet over time; and
determining, based on the received positional information, the energy consumption information, the electric energy storage capacity associated with each vehicle in the group of vehicles and the locations associated with the installed charging points of the group of installed charging points, a number of additional charging points, an optimal location within the area associated with each of the additional charging points and an optimal electric energy storage capacity associated with each of the one or more vehicles, wherein the number of additional charging points, the optimal locations associated with each of the additional charging points and the optimal electric energy storage capacities associated with the one or more vehicles are determined such that the number of additional charging points is minimized and utilizations of the optimal electric energy storage capacities are maximized.

10. The computer-implemented method of claim 9 further comprising the steps of:
receiving further constraint information; and
setting limits on the number of additional charging points and the optimal electric storage capacities associated with the one or more vehicles based on the received further constraint information.

11. The computer-implemented method of claim 10, wherein the limits are upper limits and the constraint information includes one or more of:
a projected financial cost of providing the additional charging points; a projected financial cost of providing the optimal electric storage capacities associated with the one or more vehicles;
one or more locations in the area identified as being unsuitable for a location of an additional charging point;
a maximum optimal electric storage capacity value associated with the one or more vehicles; and
a maximum value for a total number of the additional charging points and installed charging points in the area.

12. The computer-implemented method of claim 10, wherein the limits are lower limits and the constraint information includes one or more of:
a target value of greenhouse gas emission savings over a period of time resulting from an electrification characterized by a provisioning of the additional charging points and the optimal electric charging capacities associated with the one or more vehicles; and
a target electrification threshold characterized by a ratio of electric energy being used by the vehicles in the fleet to non-electric energy being used by the vehicles in the fleet over a period of time.

13. The computer-implemented method of claim 9, wherein one or more vehicles in the fleet has a zero kilowatt electric storage capacity.

14. The computer-implemented method of claim 13, wherein the group of installed charging points comprises zero charging points.

15. The computer-implemented method of claim 9, wherein the step of determining the number of additional charging points, the optimal locations and optimal electric storage capacities associated with each of the one or more vehicles is performed using one or more machine learning models.

16. (canceled)

17. An energy distribution system for a fleet of vehicles, the system comprising:
one or more electric energy storage devices associated with each vehicle in a group of vehicles; and
one or more electric charging points configured to wirelessly charge the one or more electric energy storage devices, each electric charging point being positioned at a specific location in an area,
wherein the specific locations of the one or more charging points and a number of electric energy storage devices are determined using previous location information and previous energy consumption information associated with the group of vehicles.

18. The energy distribution system of claim 17, wherein the one or more electric energy storage devices comprise one or more low storage capacity, rapid recharge, high cycle life electric energy storage devices.

19. The energy distribution system of claim 18, wherein the one or more low storage capacity, rapid recharge, high cycle life electric energy storage devices comprise supercapacitors.

20. The energy distribution system of claim 17, wherein the one or more electric charging points are configured to wirelessly charge the one or more electric energy storage devices using Resonant Magnetic Induction (RMI) charging.

21. The energy distribution system of claim 17, further comprising:
a secondary electric energy source associated with each vehicle in the group of vehicles, each secondary electric energy source associated with a vehicle being configured to charge the electric energy storage devices associated with the vehicle.

22. The energy distribution system of claim 21, wherein the secondary electric energy source comprises an internal combustion engine and an electric generator.

23-29. (canceled)
